(19) United States
(12) Patent Application Publication
(10) Pub. No.: US 2025/0388100 A1
(43) Pub. Date: Dec. 25, 2025

(54) Inlet Assembly

(71) Applicant: Tyco Electronics AMP Korea Co., Ltd., Gyeongsan (KR)

(72) Inventors: Ha Nam Kim, Gyeongsan-Si (KR); Young-Geun Park, Gyeongsan-Si (KR); Young Jin Park, Gyeongsan-Si (KR)

(73) Assignee: Tyco Electronics AMP Korea Co., Ltd., Gyeongsan (KR)

(21) Appl. No.: 19/249,103

(22) Filed: Jun. 25, 2025

(30) Foreign Application Priority Data
Jun. 25, 2024 (KR) 10-2024-0082854
May 15, 2025 (KR) 10-2025-0063003

(51) Int. Cl. B60L 53/18; B60L 53/10; B60L 53/16; H01R 13/52; H01R 13/6592

(52) U.S. Cl. CPC B60L 53/18; B60L 53/11; B60L 53/16; H01R 13/6592; H01R 13/5205; H01R 2201/26

(57) ABSTRACT

An inlet assembly includes an inlet housing installed on a mount housing on a vehicle, a power cable having at least a portion accommodated in the inlet housing, a ground clip electrically connected to a shield layer in the power cable in the inlet housing, a ground cover having a bidirectional insertion structure, and a ground cable. The power cable transmits a power received from an outside of the vehicle. A side of the bidirectional insertion structure is connected to the ground clip. The ground cable is connected to another side of the bidirectional insertion structure and is fastened to the ground clip through the bidirectional insertion structure.

### CROSS-REFERENCE TO RELATED APPLICATIONS

This application claims the benefit of the filing date under 35 U.S.C. § 119 (a)-(d) of Korean Patent Application No. 10-2024-0082854, filed on Jun. 25, 2024, and Korean Patent Application No. 10-2025-0063003, filed on May 15, 2025.

### FIELD OF THE INVENTION

The present invention relates to an assembly and, more particularly, to an inlet assembly.

### BACKGROUND OF THE INVENTION

In general, an electric vehicle requires higher voltage and/or higher current than a conventional vehicle. Therefore, an electric vehicle is equipped with a charging inlet device to efficiently charge the power of a vehicle by receiving external power.

An electric vehicle is a vehicle that uses energy stored in a battery as an energy source, and the battery is discharged after a certain period of use. When the battery is discharged, the vehicle cannot be driven, so the battery is usually configured to be charged and reused before the battery is discharged. To this end, an inlet that charges the battery of a vehicle from an external power source is installed on an electric vehicle, and an outlet that is fastened to the inlet and charges the electric vehicle is formed. Furthermore, an inlet device requires a structure to protect an electronic circuit sensitive to high voltage and/or high current from external electromagnetic interference (EMI).

The above description is information the inventors acquired during the course of conceiving the present disclosure, or already possessed at the time, and is not necessarily art publicly known before the present application was filed.

### SUMMARY OF THE INVENTION

An inlet assembly includes an inlet housing installed on a mount housing on a vehicle, a power cable having at least a portion accommodated in the inlet housing, a ground clip electrically connected to a shield layer in the power cable in the inlet housing, a ground cover having a bidirectional insertion structure, and a ground cable. The power cable transmits a power received from an outside of the vehicle. A side of the bidirectional insertion structure is connected to the ground clip. The ground cable is connected to another side of the bidirectional insertion structure and is fastened to the ground clip through the bidirectional insertion structure.

### BRIEF DESCRIPTION OF DRAWINGS

The invention will now be described by way of example with reference to the accompanying figures, of which:

FIG. 1 is a perspective view of an inlet assembly installed on a vehicle panel according to an embodiment;

FIG. 2 is an exploded perspective view of the inlet assembly of FIG. 1;

FIG. 3 is a partially cutaway perspective view of a power cable, an inner ferrule, an outer ferrule, a ground clip, and a ground case installed on an inlet housing of the inlet assembly of FIG. 1;

FIG. 4 is a cross-sectional view of a process of installing the outer ferrule of FIG. 3 in a state in which the inner ferrule of FIG. 3 is installed on the power cable of FIG. 3, with the outer ferrule not yet installed;

FIG. 5 is another cross-sectional view of the process of installing the outer ferrule of FIG. 3 in a state in which the inner ferrule of FIG. 3 is installed on the power cable of FIG. 3, with the outer ferrule installed;

FIG. 6 is a cross-sectional view of the inlet housing of FIG. 3;

FIG. 7 is a perspective view of a connection relationship between the ground clip of FIG. 3, the ground case of FIG. 3, and a ground cable according to an embodiment;

FIG. 8 is a plan view of a structure in a planar unfolded state to form the ground clip of FIG. 3, according to an embodiment; and

FIG. 9 is an enlarged view of a portion A of FIG. 6.

### DETAILED DESCRIPTION

Hereinafter, embodiments will be described in detail with reference to the accompanying drawings. However, various alterations and modifications may be made to the embodiments. Here, the embodiments are not to be construed as limited to the disclosure. The embodiments should be understood to include all changes, equivalents, and replacements within the idea and the technical scope of the disclosure.

The terminology used herein is for the purpose of describing particular embodiments only and is not to be limiting of the embodiments. The singular forms “a”, “an”, and “the” are intended to include the plural forms as well, unless the context clearly indicates otherwise. It will be further understood that the terms “comprises/comprising” and/or “includes/including” when used herein, specify the presence of stated features, integers, steps, operations, elements, and/or components, but do not preclude the presence or addition of one or more other features, integers, steps, operations, elements, components and/or groups thereof.

As used herein, “A or B”, “at least one of A and B”, “at least one of A or B”, “A, B or C”, “at least one of A, B and C”, and “at least one of A, B, or C,” each of which may include any one of the items listed together in the corresponding one of the phrases, or all possible combinations thereof.

Unless otherwise defined, all terms including technical and scientific terms used herein have the same meaning as commonly understood by one of ordinary skill in the art to which embodiments belong. It will be further understood that terms, such as those defined in commonly-used dictionaries, should be interpreted as having a meaning that is consistent with their meaning in the context of the relevant art and will not be interpreted in an idealized or overly formal sense unless expressly so defined herein.

In the descriptions of the embodiments referring to the accompanying drawings, like reference numerals refer to like elements and any repeated description related thereto will be omitted. In the description of embodiments, detailed description of well-known related structures or functions will be omitted when it is deemed that such description will cause ambiguous interpretation of the present disclosure.

Also, in the description of the components, terms such as first, second, A, B, (a), (b) or the like may be used herein when describing components of the embodiments. Each of these terms is not used to define an essence, order, or sequence of corresponding components, but used merely to distinguish the corresponding components from other components. When one constituent element is described as being “connected”, “coupled”, or “attached” to another constituent element, it should be understood that one constituent element can be connected or attached directly to another constituent element, and an intervening constituent element can also be “connected”, “coupled”, or “attached” to the constituent elements.

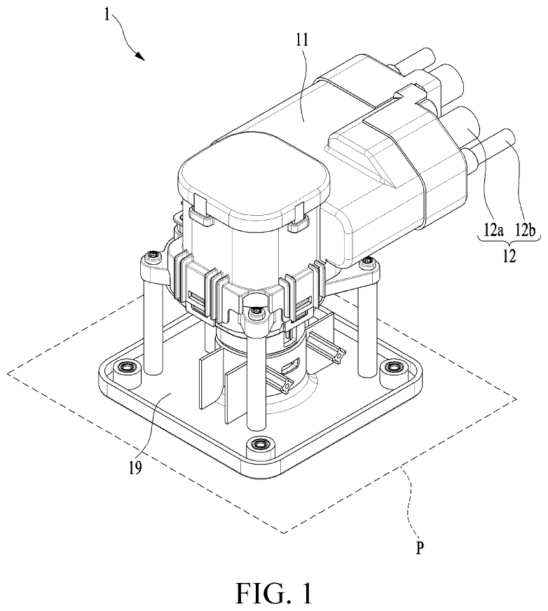

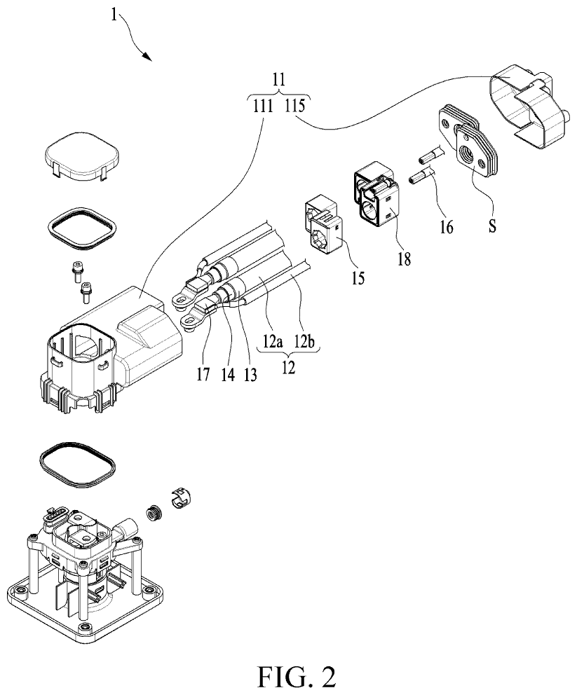

Referring to FIGS. 1-2, an inlet assembly 1 according to an embodiment may be installed on a vehicle, receive power from the outside of the vehicle, and transmit the power to an electronic component (e.g., a battery) provided inside the vehicle. Furthermore, in the process of transmitting power through the inlet assembly 1, electromagnetic interference (EMI) may occur in nearby components, and such EMI may cause an operational error of the electronic component, such as by acting as noise on the electronic component provided inside the vehicle, but the inlet assembly 1 according to an embodiment may reduce such a problem.

As shown in FIGS. 1-2, the inlet assembly 1 may include an inlet housing 11, a power cable 12, an inner ferrule 13, an outer ferrule 14, a ground clip 15, a ground cable 16, a connection terminal 17, a ground cover 18, and a mount housing 19. Hereinafter, a case in which the inner ferrule 13 and the outer ferrule 14 are each provided is described as an example. However, only one of the inner ferrule 13 and the outer ferrule 14 may be provided. For example, the inner ferrule 13 and the outer ferrule 14 may be collectively referred to as a “ferrule.”

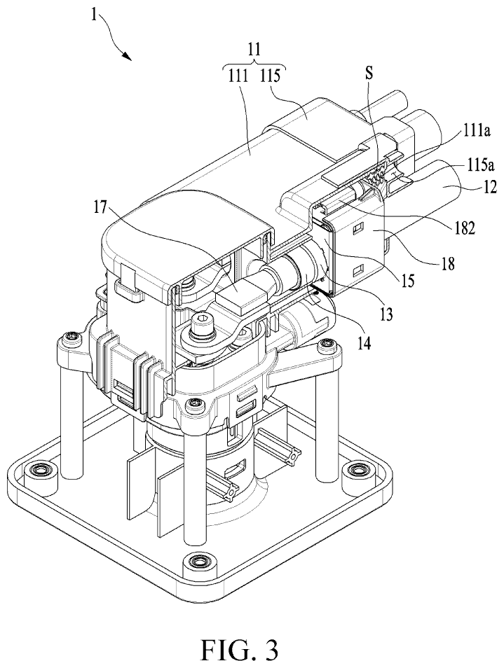

As shown in FIGS. 1 and 3, the inlet housing 11 may be installed on the mount housing 19 that is installed on the vehicle. The inlet housing 11 may be formed of, for example, an insulating material (e.g., a resin), thereby reducing the problem of current leaking from the power cable 12 to the outside. The inlet housing 11 may include a housing body 111, as shown in FIGS. 2-3 and 6, that provides a space into which the power cable 12 is inserted and a housing cover 115 that includes a hole through which the power cable 12 may pass and shields one side (e.g., an inlet side in which the power cable 12 is inserted into the inlet housing 11) of the inlet housing 11.

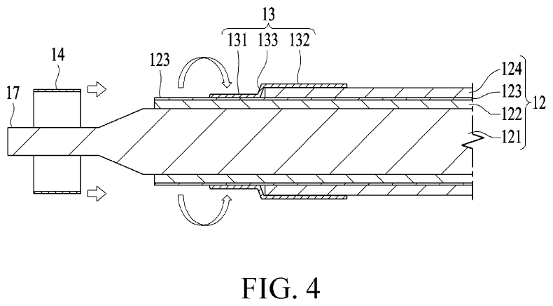

As shown in FIG. 3, at least a portion of the power cable 12 may be accommodated in the inlet housing 11. Additionally, the power cable 12 may transmit power received from the outside of the vehicle to an internal electronic component of the vehicle. At least a portion of the power cable 12 may be accommodated in the inlet housing 11. For example, a conductive wire 121 (see FIG. 4) of the power cable 12 may be butt-welded to the connection terminal 17. Through this method, the reliability of power transmission may be improved by ensuring high bonding strength.

As shown in FIGS. 1-2, the power cable 12 may, for example, include a plurality of power cables 12a and 12b. The plurality of power cables 12a and 12b may include a first cable 12a that transmits charging current in the form of direct current (DC) and a second cable 12b that transmits charging current in the form of alternating current (AC). For example, at least one (e.g., the first cable 12a) of the first cable 12a and the second cable 12b may be formed having a shield cable structure including double-insulation sheaths 122 and 124, and a shield layer 123 (see FIG. 4) formed of a conductive material positioned between the double-insulation sheaths 122 and 124. An example of a description of the shield cable structure is described below. For example, the first cable 12a may be formed having the shield cable structure with the double-insulation sheaths 122 and 124 described above, and the second cable 12b may be formed having a general cable structure with one insulating sheath.

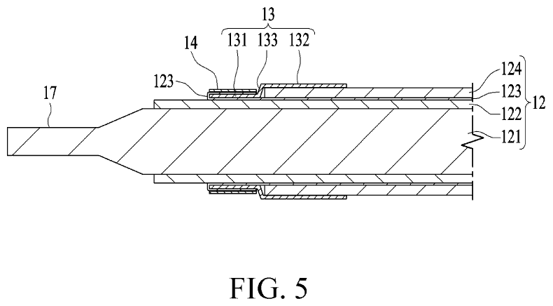

For example, as shown in FIGS. 4-5, the conductive wire 121 of the first cable 12a and the conductive wire 121 of the second cable 12b may be butt-welded to the connection terminal 17. FIG. 2 illustrates the conductive wire 121 of the first cable 12a and the conductive wire 121 of the second cable 12b interconnected. According to this structure, the power cable 12 may receive charging current in the form of DC or AC from the outside of the vehicle through the same connection terminal 17 and may charge the vehicle through the first cable 12a or the second cable 12b. That is, since there is no need to form the connection terminal 17 for each of the plurality of power cables 12a and 12b, the number of components and the total volume of the inlet assembly 1 may be reduced, and the manufacturing cost and time may be reduced. Through this method, the number of manufacturing processes may be reduced while ensuring high bonding strength, thereby saving manufacturing cost and time.

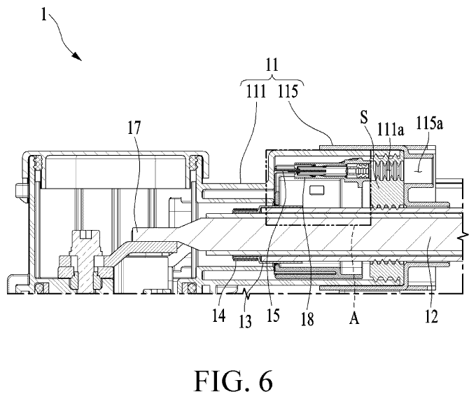

The inner ferrule 13 may reduce EMI by contacting the shield layer 123 of the power cable 12, as shown in FIGS. 4-5, and form a conductive path from the power cable 12 to the ground clip 15, as shown in FIG. 6. An example of the inner ferrule 13 is described with reference to FIG. 3 and below.

The outer ferrule 14 may perform a function of surrounding the shield layer 123 of the power cable 12, as shown in FIG. 5, so that the shield layer 123 does not deviate from the inner ferrule 13. An example of the outer ferrule 14 is described with reference to FIG. 3 and below.

As shown in FIG. 3, the ground clip 15 may be electrically connected to the shield layer 123 provided in the power cable 12 in the inlet housing 11. The ground clip 15 may be formed of a conductive material (e.g., a metal) and may perform a function of transmitting current leaking from the power cable 12 to the ground cable 16 through the ground cover 18. An example of a structure of the ground clip 15 is described below with reference to the drawings.

The ground cable 16 may ground current leaking from the power cable 12. One end of the ground cable 16 may be fastened to the ground clip 15 that is inserted into the ground cover 18, and the other end of the ground cable 16 may be electrically connected to a ground structure, for example, a vehicle panel P positioned outside the inlet housing 11. For example, one end of the ground cable 16 may be connected to the ground clip 15 by penetrating the housing cover 115, and the other end of the ground cable 16 may be directly or indirectly connected to the vehicle panel P. The other end of the ground cable 16 may be, for example, indirectly connected to the vehicle panel P through a metal structure (e.g., a fastening structure such as an insert nut) of the mount housing 19.

The connection terminal 17 may be connected to an external charging device connector and may transmit power to the power cable 12. For example, as shown in FIG. 2, the connection terminal 17 may have a plate shape. As further shown in FIG. 2, the connection terminal 17 may include a rigid conductive material and be provided in a plate shape (e.g., a rectangular shape) having a sufficient width so that the conductive wire 121 of the plurality of power cables 12a and 12b may contact. With this structure, the connection terminal 17 and the plurality of power cables 12a and 12b may be physically and/or electrically connected through butt welding as described above.

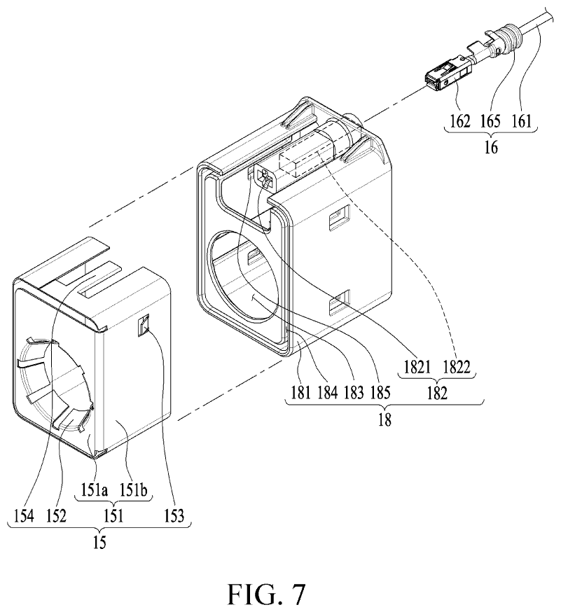

The ground cover 18 may include a bidirectional insertion structure 182, as shown in FIG. 7, of which one side is connected to the ground clip 15 and the other side is connected to the ground cable 16. The ground cover 18 may be formed of an insulating material (e.g., a resin) and may have a shape surrounding at least a portion (e.g., a side surface) of the ground clip 15. With this structure, it may be possible to reduce leakage of current, which is transmitted from the ground clip 15 to the ground cable 16, to other components. An example of a structure of the ground cover 18 is described below with reference to the drawings.

The mount housing 19 may be fastened to the inlet housing 11, as shown in FIGS. 1 and 3, and may support the inlet housing 11 with respect to the vehicle panel P. For example, the mount housing 19 may include, but is not limited thereto, a fastening bolt that may be fastened to the vehicle panel P and/or a hole structure through which the fastening bolt may pass. For example, at least a portion of the mount housing 19 may be formed of a conductive material. With this structure, a ground line 161 that may transmit current leaking from the power cable 12 to the vehicle panel P through the ground cable 16 and the mount housing 19 may be formed.

As shown in FIG. 3, the housing body 111 according to an embodiment may include a body ground hole 111a into which the ground cable 16 may be inserted. The housing body 111 may, for example, include a housing seal S that is installed on a surface facing the housing cover 115 and configured to reduce foreign materials introduced from the outside of a vehicle. For example, it should be noted that the body ground hole 111a may be formed in the housing seal S, as shown in FIGS. 2-3. As shown in FIG. 3, the housing cover 115 according to an embodiment may include a cover ground hole 115a through which the ground cable 16 may pass. According to the body ground hole 111a and the cover ground hole 115a, the ground cable 16 may be inserted into the bidirectional insertion structure 182 formed in the ground cover 18. An example of a structure of the bidirectional insertion structure 182 is described below.

As shown in FIGS. 4-5, the power cable 12 according to an embodiment may be formed having a shield cable structure including double-insulation sheaths 122 and 124 and the shield layer 123 formed of a conductive material positioned between the double-insulation sheaths 122 and 124. The power cable 12 may include the conductive wire 121 formed of a conductive material, an inner insulation layer 122 surrounding the conductive wire 121, an outer insulation layer 124 surrounding the inner insulation layer 122, and the shield layer 123 for transmitting current leaking from the conductive wire 121 to the outside. As shown in FIG. 5, for example, at least a portion of the shield layer 123 may be surrounded by the inner ferrule 13, and at least a portion of the shield layer 123 may be surrounded by the outer ferrule 14.

A portion of the inner ferrule 13 may contact the shield layer 123, as shown in FIGS. 4-5, and a remaining portion of the inner ferrule 13 may contact the ground clip 15. As shown in FIGS. 4-5, the inner ferrule 13 may include a first portion 131 contacting the outer surface of a portion of the shield layer 123, which is not surrounded by the outer insulation layer 124, a second portion 132 contacting the ground clip 15, and a connecting portion 133 that connects the first portion 131 to the second portion 132.

The first portion 131 may be positioned at a portion of the power cable 12 in which the outer insulation layer 124 is stripped. As shown in FIGS. 4-5, the shield layer 123 may be exposed to the portion in which the outer insulation layer 124 is stripped. The first portion 131 may be installed to surround at least a portion of the outer surface of the portion of the shield layer 123 that is exposed outwardly.

The second portion 132 may have a diameter that is greater than that of the first portion 131 and may surround the outermost circumferential surface of the power cable 12. As shown in FIGS. 4-5, the second portion 132 may be provided to surround a portion of the outer insulation layer 124, which is positioned close to the stripped portion, thereby preventing the outer insulation layer 124 from being separated from the power cable 12.

The connecting portion 133 may be a portion that interconnects the first portion 131 and the second portion 132, which have different diameters, and may have, for example, a truncated cone shape. Through the connecting portion 133, current leaking into the first portion 131 may be transmitted to the second portion 132. For example, the connecting portion 133 may reduce foreign materials from flowing between the outer insulation layer 124 and the shield layer 123.

The shield layer 123 may be formed of a conductive material and may have, for example, a mesh shape but is not limited thereto. As shown in FIGS. 4-5, at least a portion of the shield layer 123 may be positioned between the inner insulation layer 122 and the outer insulation layer 124. The remaining portion of the shield layer 123 may surround the first portion 131 of the inner ferrule 13, as shown in FIG. 5, in a reverse-folded form along the arrow direction of FIG. 4 from an end portion of the at least a portion of the shield layer 123 described above. According to this structure, the shield layer 123 may contact both the inner surface and the outer surface of the first portion 131 of the inner ferrule 13, thereby effectively transmitting current leaking from the conductive wire 121 to the inner ferrule 13.

In this state, the outer ferrule 14 may be installed to surround the outer surface of the reverse-folded form of the shield layer 123, as shown in FIG. 5. With this structure, the shield layer 123 and the inner ferrule 13 may be maintained in a stable contact state with each other.

The current leaking from the conductive wire 121 may, for example, be sequentially transmitted along the shield layer 123, the inner ferrule 13, and the ground clip 15, and as described below, the current may be transmitted to the outside through the ground cable 16 connected to the ground clip 15.

As shown in FIGS. 7-9, the ground clip 15 according to an embodiment may include a clip body 151 having a hole H through which the power cable 12 may pass, a contact protrusion 152 protruding toward the center of the hole H of the clip body 151 and contacting the inner ferrule 13, a fixing tab 153 protruding from the clip body 151 to the outside and fixable to the ground cover 18, and a ground tab 154 extending from the clip body 151 and inserted into the bidirectional insertion structure 182.

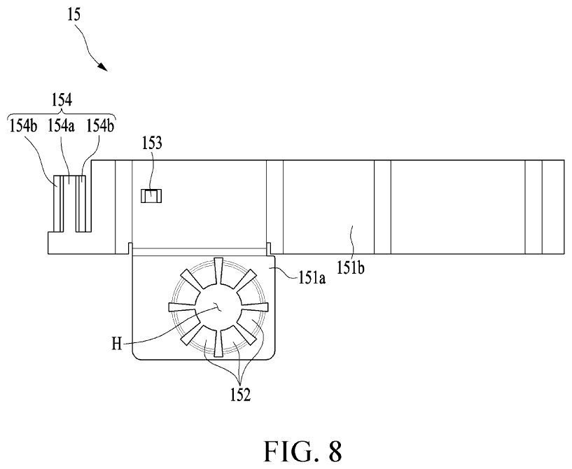

According to an embodiment, the ground clip 15 may be formed by cutting and bending one metal plate, as shown in FIG. 8. FIG. 8 illustrates one metal plate cut to form the ground clip 15, and the ground clip 15 having a shape as shown in FIG. 7 may be formed by bending the metal plate in the state as shown in FIG. 8. Furthermore, unless otherwise stated, it should be noted that the ground clip 15 does not necessarily have to be formed by cutting and bending one metal plate. For example, the ground clip 15 may have a shape as shown in FIG. 7 by bonding (e.g., welding) a plurality of plates.

The clip body 151 may include a support plate 151a, as shown in FIGS. 7-8, forming a surface that is perpendicular to a direction through which the power cable 12 passes and a side surface plate 151b, as shown in FIGS. 7-8, arranged along the circumferential direction of the support plate 151a. The hole H through which the power cable 12 may pass through, for example, may be formed in the support plate 151a. For example, the fixing tab 153 and the ground tab 154 may be formed in the side surface plate 151b.

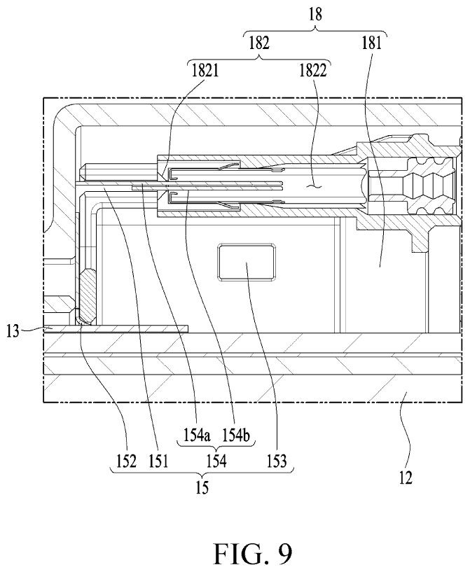

As shown in FIG. 8, the contact protrusion 152 may have a shape extending from the edge of the hole H toward the center of the hole H. For example, a plurality of contact protrusions 152 may be spaced apart along the edge of the hole H. For example, the plurality of contact protrusions 152 may be radially arranged based on the center of the hole H. As shown in FIG. 7, the contact protrusion 152, for example, may have a shape that is bent to be inclined from the support plate 151a toward a cable hole 183 of the ground cover 18. The contact protrusion 152 may have a shape that is inclined toward the housing cover 115 toward the center of the hole H. With the shape as described above, the ground clip 15 may be smoothly engaged with the power cable 12 in the state as shown in FIG. 2. In the final assembled state, the contact protrusion 152 may contact the inner ferrule 13, as shown in FIG. 9, so that current leaking from the power cable 12 may be transmitted to the outside by sequentially passing through the inner ferrule 13, the contact protrusion 152, the clip body 151, the ground tab 154, and the ground cable 16.

The fixing tab 153 may be formed, for example, by cutting a portion of the clip body 151. For example, the fixing tab 153 may be formed by cutting a portion of the side surface plate 151b and bending the cut portion so that the cut portion protrudes from the side surface plate 151b outwardly. As shown in FIG. 7, the direction in which an end portion of the fixing tab 153 faces is opposite to the direction in which an end portion of the ground tab 154 faces, so that the fastening force between the ground clip 15 and the ground cover 18 may be improved, and the fastening force between the ground tab 154 and the bidirectional insertion structure 182 of the ground cover 18 may also be improved.

As shown in FIG. 9, the ground tab 154 may be fastened to the bidirectional insertion structure 182 of the ground cover 18. The ground tab 154 may have a shape extending from the side surface plate 151b toward the housing cover 115. For example, as shown in FIGS. 8-9, the ground tab 154 may include a tab body 154a and a wing portion 154b arranged on at least one of both sides of the tab body 154a. For example, at least one wing portion 154b may be bent (see FIG. 9) to overlap in the thickness direction of the tab body 154a. With this structure, by increasing the rigidity of the ground tab 154, the problem of the ground tab 154 being damaged during the process of fastening the ground tab 154 to the bidirectional insertion structure 182 and/or the ground cable 16 may be reduced.

As shown in FIG. 7, according to an embodiment, the ground cable 16 may include a ground line 161 including a conductive material, a ground receptacle 162 provided at one end of the ground line 161 and connected to the ground tab 154, and a ground side seal 165 for reducing foreign materials flowing into the ground line 161 from the outside of a vehicle.

The ground receptacle 162 may be inserted into the bidirectional insertion structure 182 of the ground cover 18. As shown in FIG. 7, the ground line 161 may be connected to one end of the ground receptacle 162, and a groove capable of accommodating the ground tab 154 may be formed at the other end of the ground receptacle 162. A contact structure capable of elastically contacting the ground tab 154 may be formed at the other end of the ground receptacle 162.

The ground side seal 165 may seal between the ground line 161 and the body ground hole 111a. For example, when the body ground hole 111a is formed inside the housing seal S, as shown in FIG. 3, through a double-seal structure, it may be possible to effectively reduce the problem of foreign materials flowing into the bidirectional insertion structure 182.

As shown in FIG. 7, the ground cover 18 according to an embodiment may include a cover body 181, the bidirectional insertion structure 182, the cable hole 183, a clip groove 184, and a caught portion 185. For example, the cover body 181 is a portion that forms the overall outer shape of the ground cover 18 and may support the bidirectional insertion structure 182.

The bidirectional insertion structure 182 may have a tab hole 1821, as shown in FIGS. 7 and 9, into which the ground tab 154 is inserted, and a receptacle groove 1822, as shown in FIGS. 7 and 9, into which the ground receptacle 162 is inserted. For example, the tab hole 1821 and the receptacle groove 1822 may be positioned at both ends of the bidirectional insertion structure 182. The longitudinal direction of the bidirectional insertion structure 182, for example, may be parallel to the longitudinal direction of the power cable 12 but is not limited thereto. Additionally, for example, the tab hole 1821 may be recessed toward the housing cover 115, and the receptacle groove 1822 may be recessed in a direction in which the power cable 12 is inserted into the inlet housing 11. The receptacle groove 1822 may be communicated with the tab hole 1821. The ground tab 154 inserted through the tab hole 1821 may be exposed to the receptacle groove 1822 so that the ground tab 154 may be inserted into the ground receptacle 162.

As shown in FIG. 7, the cable hole 183 may be formed to penetrate the cover body 181. The power cable 12 may pass through the ground cover 18 through the cable hole 183.

The clip groove 184 may be recessed in a direction (e.g., a direction toward the housing cover 115) in which the power cable 12 extends from the outer surface of the cover body 181. The side surface plate 151b of the ground clip 15 may be inserted into the clip groove 184. By the shape as described above, it may be possible to reduce the direct contact of the side surface plate 151b of the ground clip 15 formed of a conductive material with other components.

As shown in FIG. 7, the caught portion 185 is a portion to which the fixing tab 153 of the ground clip 15 is caught and the caught portion 185 may be formed on the side surface of the cover body 181. For example, the caught portion 185 may have a groove shape that is recessed from the inner wall of the cover body 181 outwardly. The end portion of the fixing tab 153, for example, may be caught by the caught portion 185 so that the fastening force of the ground clip 15 and the ground cover 18 may be improved.

Although the embodiments have been described with reference to the limited drawings, one of ordinary skill in the art may apply various technical modifications and variations based thereon. For example, suitable results may be achieved if the described techniques are performed in a different order, and/or if components in a described system, architecture, device, or circuit are combined in a different manner, or replaced or supplemented by other components or their equivalents. Therefore, other implementations, other embodiments, and/or equivalents of the claims are within the scope of the following claims.

1. An inlet assembly comprising:
an inlet housing installed on a mount housing, the mount housing is installed on a vehicle;
a power cable of which at least a portion is accommodated in the inlet housing, the power cable transmits a power received from an outside of the vehicle;
a ground clip electrically connected to a shield layer in the power cable in the inlet housing;
a ground cover having a bidirectional insertion structure, a side of the bidirectional insertion structure is connected to the ground clip; and
a ground cable connected to an other side of the bidirectional insertion structure and fastened to the ground clip through the bidirectional insertion structure.

2. The inlet assembly of claim 1, wherein the power cable includes a first cable transmitting a direct current (DC) charging current.

3. The inlet assembly of claim 2, wherein the power cable includes a second cable transmitting an alternating current (AC) charging current.

4. The inlet assembly of claim 3, wherein the first cable includes:
a conductive wire formed of a conductive material;
an inner insulation layer surrounding the conductive wire;
an outer insulation layer surrounding the inner insulation layer; and
the shield layer of which at least a portion is positioned between the inner insulation layer and the outer insulation layer, the shield layer shielding an electromagnetic wave generated from the conductive wire.

5. The inlet assembly of claim 4, wherein the first cable includes an inner ferrule of which a portion contacts the shield layer and a remaining portion contacts the ground clip.

6. The inlet assembly of claim 5, wherein the inner ferrule has a first portion contacting an outer surface of at least a portion of the shield layer which is not surrounded by the outer insulation layer, a second portion contacting the ground clip, and a connecting portion connecting the first portion to the second portion.

7. The inlet assembly of claim 6, wherein a remaining portion of the shield layer that is not contacted by the first portion of the inner ferrule surrounds the first portion of the inner ferrule in a reverse-folded form.

8. The inlet assembly of claim 7, further comprising an outer ferrule surrounding an outer surface of the reverse-folded form of the shield layer.

9. The inlet assembly of claim 3, wherein the ground clip includes:
a clip body having a hole through which the first cable passes,
a contact protrusion protruding toward a center of the hole of the clip body and contacting a ferrule formed of a conductive material, and
a ground tab extending from the clip body and inserted into the bidirectional insertion structure, the ferrule surrounds the first cable.

10. The inlet assembly of claim 9, wherein the ground cable includes a ground line having a conductive material and a ground receptacle provided at an end of the ground line.

11. The inlet assembly of claim 10, wherein the ground receptacle is inserted into the bidirectional insertion structure and accommodates the ground tab.

12. The inlet assembly of claim 11, wherein the bidirectional insertion structure has a tab hole into which the ground tab insertable, and a receptacle groove communicating with the tab hole and into which the ground receptacle is insertable.

13. The inlet assembly of claim 1, wherein the ground cover includes:
a cover body supporting the bidirectional insertion structure,
a cable hole penetrating the cover body and through which the power cable passes, and
a clip groove that is recessed from an outer surface of the cover body in a direction in which the power cable extends and into which a side surface plate of the ground clip is insertable.

14. The inlet assembly of claim 1, wherein a longitudinal direction of the bidirectional insertion structure is parallel to a longitudinal direction of the power cable.

15. The inlet assembly of claim 1, further comprising a connection terminal having a plate shape, the connection terminal connects to an external charging device connector and transmits the power to the power cable.

16. The inlet assembly of claim 3, further comprising a connection terminal having a plate shape, the connection terminal connects to an external charging device connector and transmits the power to the power cable.

17. The inlet assembly of claim 16, wherein a conductive wire of the first cable and a conductive wire of the second cable are butt-welded to the connection terminal.

18. The inlet assembly of claim 1, wherein the ground cover is formed of an insulating material.

19. The inlet assembly of claim 1, wherein the inlet housing has a housing body, the housing body has a housing seal preventing a foreign material flowing into the bidirectional insertion structure.
